(19) United States
(12) Patent Application Publication
(10) Pub. No.: US 2005/0206615 A1
(43) Pub. Date: Sep. 22, 2005

(54) Display support mechanism for an electronic apparatus

(76) Inventors: Mitsuyoshi Tanimoto, Kanagawa (JP); Hiroshi Nakamura, Tokyo (JP); Toshiyuki Tanaka, Laguna Niguel (JP); Yves Behar, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/805,848

(22) Filed: Mar. 22, 2004

(51) Int. Cl. G09G 5/00

(52) U.S. Cl. 345/156; 361/681

(57) ABSTRACT

An electronic apparatus is designed for conversion from a portable computer configuration to a flat panel television configuration. The electronic apparatus comprises (i) a body having a first edge and a second edge, (ii) a display housing, (iii) a display adjustment unit, and (iv) a display support unit. The display adjustment unit is coupled to the display housing and is rotationally coupled to the body proximate to the first edge of the body. The display support unit is rotationally coupled to the body proximate to the second edge of the body, and when rotated, supports the display housing.

### FIELD

Embodiments of the invention generally relate to a mechanism that enables conversion of an electronic apparatus from a first operational state to a second operational state.

### GENERAL BACKGROUND

Over the past decade, there has been increased demand for laptop computers, especially in light of their enhanced data processing capabilities. Typically, conventional laptop computers feature a body and a liquid crystal display (LCD) pivotally joined to the body by a hinge shaft. Since the hinge shaft is positioned at the rear portion of the body, the LCD remains at the rear of the body at all times.

Due to the recent popularity of LCD televisions, certain models of laptop computers are now configured to alternatively operate as a LCD television. This is normally accomplished by placing a television tuner into the body, where the tuner is activated through software. In order to view content displayed on the LCD, a user places the body on a surface (e.g., the user's lap or a fixed surface) and opens the computer by pivoting the LCD away from a top surface of the body. This position of the laptop computer's LCD, however, is not conducive for prolonged viewing by a user or for remote usage by a wireless keyboard.

More specifically, since the LCD is joined at the rear of the body, the only suitable viewing perspective is when the user is looking downward at the LCD. This downward viewing perspective is uncomfortable, especially for prolonged television viewing. Moreover, since the LCD is joined at the rear of the body, the overall viewing distance is increased by the width of the body. Depending on the size of the LCD and the distance of separation between the user and the laptop computer, the addition distance caused by the width of the body may adversely affect the overall clarity of the picture as seen by the user.

Over the past few years, conventional display support mechanisms have been developed to shift the LCD toward the front of the body. While these mechanisms may alter the viewing perspective and reduce the viewing distance, they have failed to provide take into account, and in many cases may degrade, the overall operability of the intended converted product.

### BRIEF DESCRIPTION OF THE DRAWINGS

Features and advantages of embodiments of the invention will become apparent from the following detailed description in which:

FIG. 1A is a perspective view of a first exemplary embodiment of an electronic Apparatus placed in a closed state without attachment of the display adjustment unit.

FIG. 1B is a perspective view of the first exemplary embodiment of an electronic apparatus placed in a closed state with attachment of the display adjustment unit.

FIG. 2 is an overhead view of the electronic apparatus shown in FIG. 1B.

FIG. 3 is a view of a bottom surface of the body of the electronic apparatus shown in FIG. 1B.

FIG. 4 is a front view of the electronic apparatus shown in FIG. 1B.

FIG. 5 is a rear view of the electronic apparatus shown in FIG. 1B.

FIG. 6 is a side view of the electronic apparatus shown in FIG. 1B.

FIG. 7 is a perspective view of the first exemplary embodiment of the electronic apparatus placed in a first operational state.

FIG. 8 is a front view of the electronic apparatus shown in FIG. 7.

FIG. 9 is a side view of the electronic apparatus shown in FIG. 7.

FIG. 10 is a rear view of the electronic apparatus shown in FIG. 7.

FIG. 11 is a rear view of the electronic apparatus after upward lateral movement of the display housing to provide sufficient clearance for interfaces positioned on the body.

FIG. 12A is a first exemplary embodiment of the mechanics of the display adjustment unit for the electronic apparatus shown in FIG. 7.

FIGS. 12B-12C are second exemplary embodiments of the mechanics of the display adjustment unit for the electronic apparatus shown in FIG. 7.

FIGS. 12D-12E are third exemplary embodiments of the mechanics of the display adjustment unit for the electronic apparatus shown in FIG. 7.

FIGS. 12F-12G are fourth exemplary embodiments of the mechanics of the display adjustment unit for the electronic apparatus shown in FIG. 7.

FIG. 13 is an overhead view of the electronic apparatus shown in FIG. 7.

FIG. 14 is a view of a bottom surface of the body of the electronic apparatus shown in FIG. 7.

FIG. 15 is a perspective view of an exemplary embodiment of the electronic apparatus having the display housing elevated and the display support unit rotated for conversion to a second operational state.

FIG. 16 is a perspective side view of the electronic apparatus during conversion as shown in FIG. 15.

FIG. 17 is a perspective view of a top surface of the body with a first embodiment of the display support unit rotated to support the display housing when the electronic apparatus is placed in the second operational state.

FIG. 18 is a perspective view of the top surface of the body with a second embodiment of the display support unit rotated to support the display housing when the electronic apparatus is placed in the second operational state.

FIG. 19 is a perspective view of the first exemplary embodiment of the electronic apparatus placed in a second operational state.

FIG. 20 is a front view of the electronic apparatus shown in FIG. 19.

FIG. 21 is a side view of the electronic apparatus shown in FIG. 19.

FIG. 22 is a rear view of the electronic apparatus shown in FIG. 19.

FIG. 23 is an overhead view of the electronic apparatus shown in FIG. 19.

FIG. 24 is a view of a bottom surface of the body of the electronic apparatus shown in FIG. 19.

FIG. 25 is a perspective view of a second exemplary embodiment of an electronic apparatus placed in a closed state.

FIG. 26 is an exemplary embodiment of a top support arm of a display adjustment unit shown in FIG. 25.

FIG. 27 is an exemplary embodiment of a bottom support arm of the display adjustment shown in FIG. 25.

FIG. 28 is a perspective view of the second exemplary embodiment of the electronic apparatus placed in a second operational state.

### DETAILED DESCRIPTION

Embodiments of the invention set forth in the following detailed description generally relate to a display support mechanism that enables conversion of an electronic apparatus from a first operational state to a second operational state. According to one embodiment of the invention, the electronic apparatus operates as a laptop computer when placed in the first operational state and as either a flat panel television or a remote-controlled computer when placed in a second operational state. In the second operational state, both the flat panel display and the rotated display support unit featuring the speakers (described below) are substantially coplanar.

In the following description, certain terminology is used to describe certain features of one or more embodiments of the invention. For instance, an “electronic apparatus” is generally defined as an electronic product with an adjustable flat panel display. In this detailed description, for clarity sake, the electronic apparatus is illustrated as a portable computer that can be converted to a flat panel television or a remote-controlled computer by movement of the display housing toward the user. A “remote-controlled computer” is a computer comprises a wireless input source (e.g., wireless keyboard, wireless joystick, remote control, etc.).

It is evident that the invention may be utilized in other types of electronic apparatus. As an illustrative example, the display support mechanism may be deployed as part of a personal digital assistant, cellular telephone, or the like.

Herein, the term “rotate” as well as varying forms thereof is generally defined as movement about an axis of rotation. Normally, the axis of rotation is fixed. For this detailed description, the term “vertical” (or varying forms thereof) is used to denote a direction of rotation based on a generally horizontal axis of rotation. The term “horizontal” (or varying forms thereof) is used to denote a direction of rotation based on a generally vertical axis of rotation. The term “lateral” is generally used to denote movement along a single plane.

### I. First Embodiment of the Electronic Apparatus

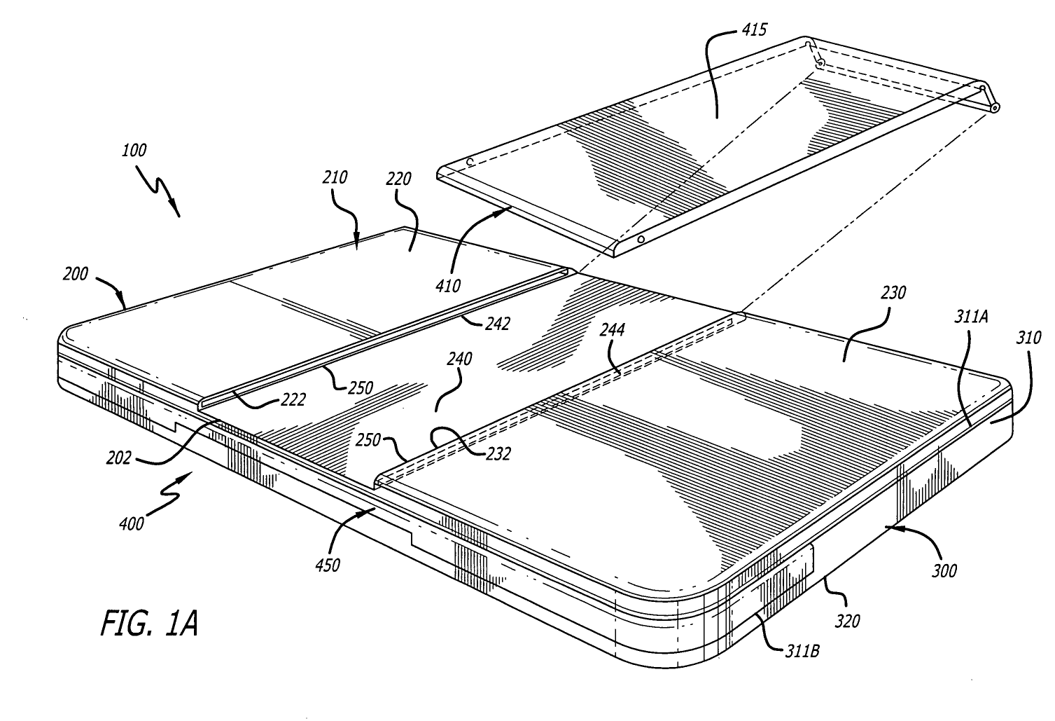

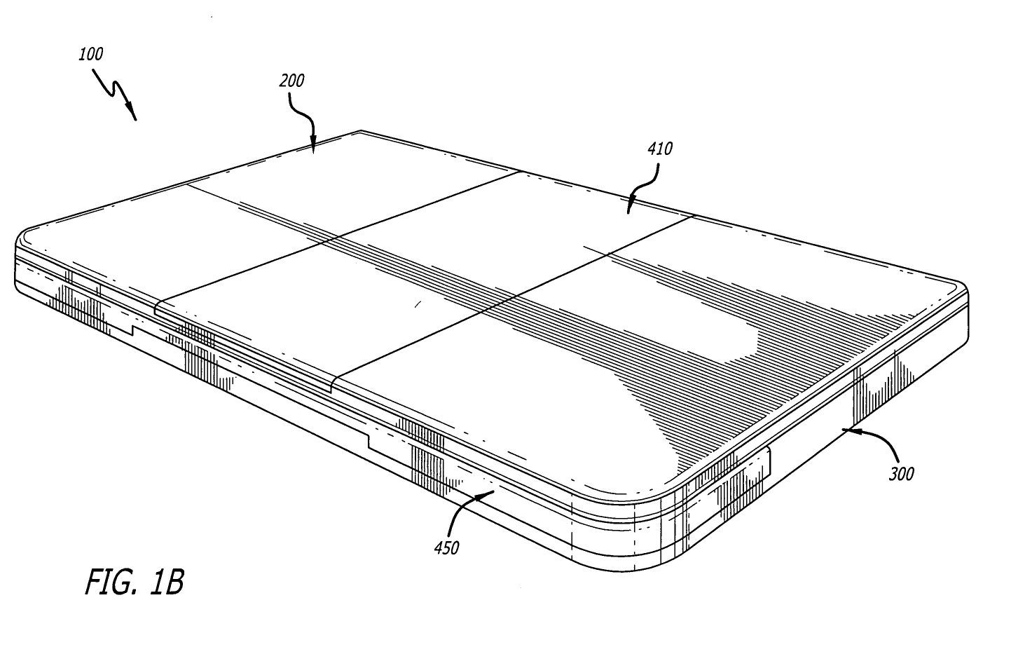

Referring to FIG. 1A, a perspective view of a first exemplary embodiment of an electronic apparatus placed in a closed state is shown. Electronic apparatus 100 comprises a display housing 200, a body 300 and a display support mechanism 400 that comprises a display adjustment unit 410 and a display support unit 450.

As shown, display housing 200 is shaped to cover the entire top surface (or at least a substantial portion) of body 300 when electronic apparatus 100 is placed in the closed state. According to this embodiment of the invention, as shown in FIG. 1B, display adjustment unit 410 is rotationally coupled to both display housing 200 and body 300 while display support unit 450 is rotationally coupled to the body 300.

Returning back to FIG. 1A, for this embodiment of the invention, a back display panel 210 of display housing 200 comprises two raised panel sections 220 and 230, which are separated by a recessed area 240. Sized with a width and depth to accommodate a support arm 415 of display adjustment unit 410, recessed area 240 comprises a footprint having a width slightly greater than the width of support arm 415. Namely, the distance between the pair of longitudinal edges 242 and 244 of recessed area 240 exceeds the width of support arm 415.

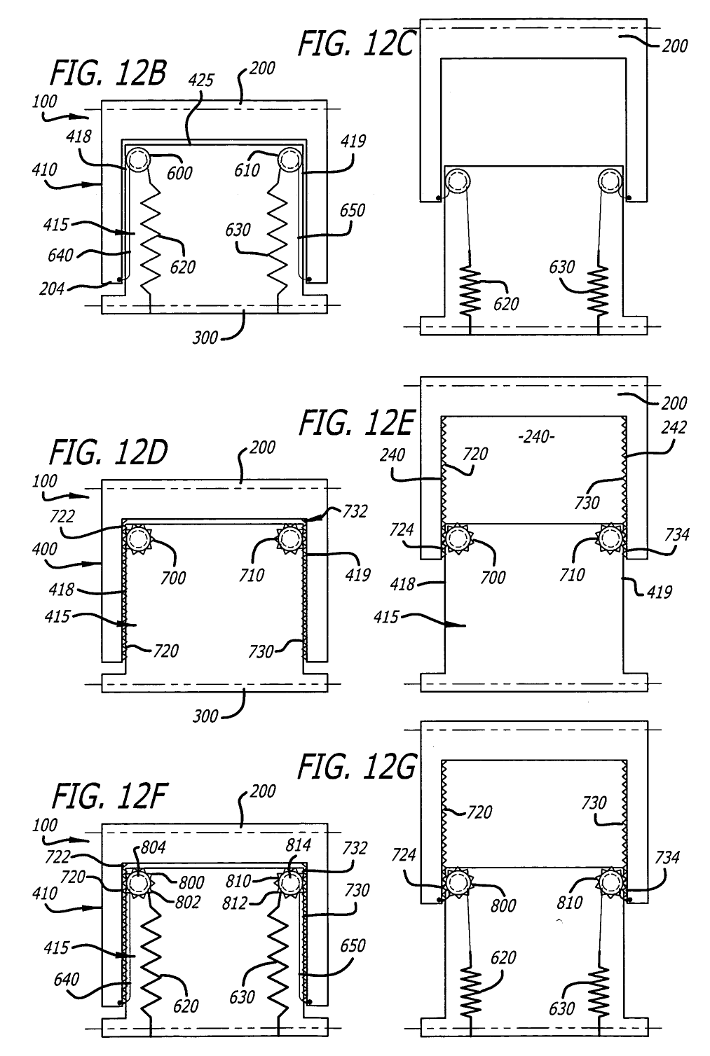

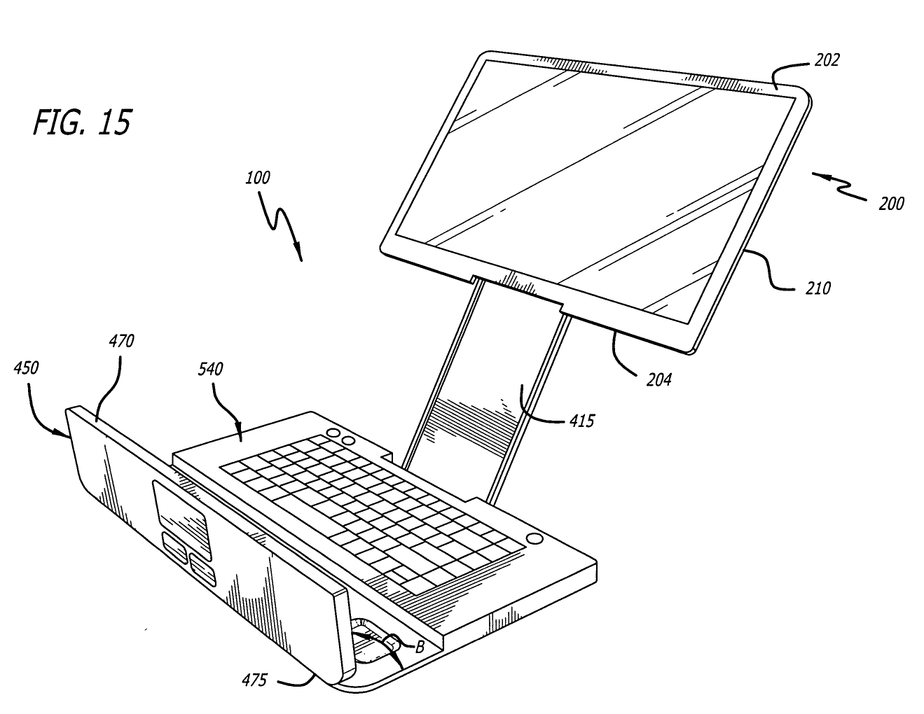

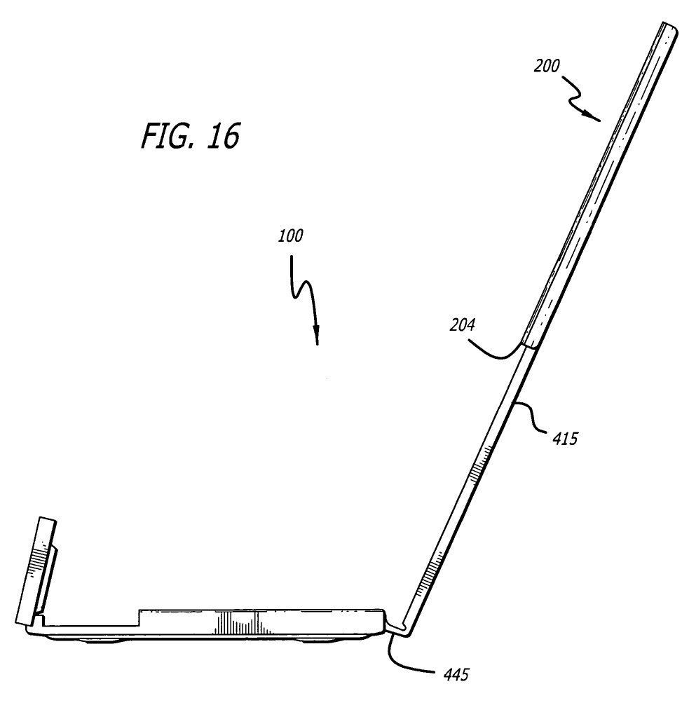

As a result, the spacing between a portion of recessed area 240 proximate to longitudinal edge 242 and a back surface 222 of panel section 220 and the spacing between a portion of recessed area 240 proximate to longitudinal edge 244 and a back surface 232 of panel section 230 generally form a pair of channel guides 250. These channel guides 250 enable lateral movement of display housing 200 as shown in FIGS. 15-16. It is contemplated that detents may be placed at various positions along these channel guides 250 to enable display housing 200 to be laterally moved and maintained at these positions as described below and illustrated in FIG. 12.

Although not shown, as an alternative embodiment, it is contemplated that channel guides may be etched into the edges of support arm 415 in lieu of recessed area 240. As a result, detents would be positioned along the edges of support arm 415 to receive a spring-loaded insert (e.g., ball bearing) positioned along longitudinal edges 242 and 244 of recessed area 240 near a bottom edge of display housing 200 for example.

As yet another alternative embodiment, it is contemplated that guide rails, separate from panel section 220 and 230 and recessed area 240, may be specifically mounted along longitudinal edges 242 and 244. These guide rails may reduce wear on the panel sections 220 and 230 due to occasional lateral movement of display housing 200.

Referring still to FIG. 1A, body 300 comprises two panels, namely a top panel 310 and a bottom panel 320. According to one embodiment of the invention, top panel 310 is designed as a two-tier panel with a first-tier 311A situated above a second-tier 311B. Made of a non-pliable material (e.g., synthetic resin), panels 310 and 320 are brought together to enclose interconnects (e.g., electrical wires, bus traces, cable, optical fiber, etc.) and components of electronic apparatus 100, thereby protecting them from foreign materials and environmental conditions.

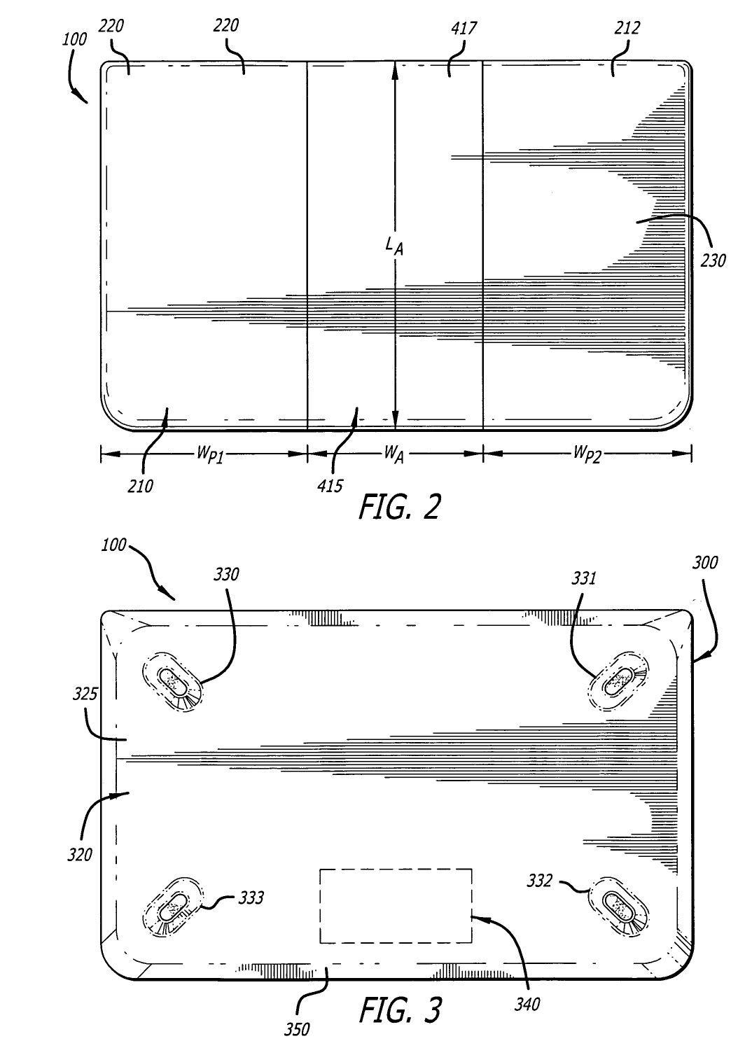

Referring now to FIG. 2, an overhead view of electronic apparatus 100 of FIG. 1B is shown. According to this embodiment of the invention, when electronic apparatus 100 is in the closed state, a top surface 212 of back display panel 210 is substantially coplanar with a top surface 417 of support arm 415.

According to this embodiment, length (L_{A}) of support arm 415 of display adjustment unit 410 is substantially equivalent to the length of panel sections 220 and 230. As a result, the combination of back display panel 210 and display adjustment unit 410 are substantially rectangular in dimension. Moreover, the width (W_{A}) of support arm 415 is less than the width of panel section 220 (W_{P1}) or panel section 230 (W_{P2}). However, it is contemplated that the width of support arm 415 may be adjusted to exceed the widths of panel section 220 and/or panel section 230.

Referring to FIG. 3, a view of a bottom surface of body 300 of electronic apparatus 100 of FIG. 1 is shown. A number of grommets 330-333 are positioned approximate to each corner of a bottom surface 325 of bottom panel 320. Grommets 330-333 prevent sliding of electronic apparatus 100 when used on a table or other flat surface. A vent 340 is positioned in close proximity to a rear edge 350 of body 300. Vent 340 enables heat dissipation (cooling) of components within body 300.

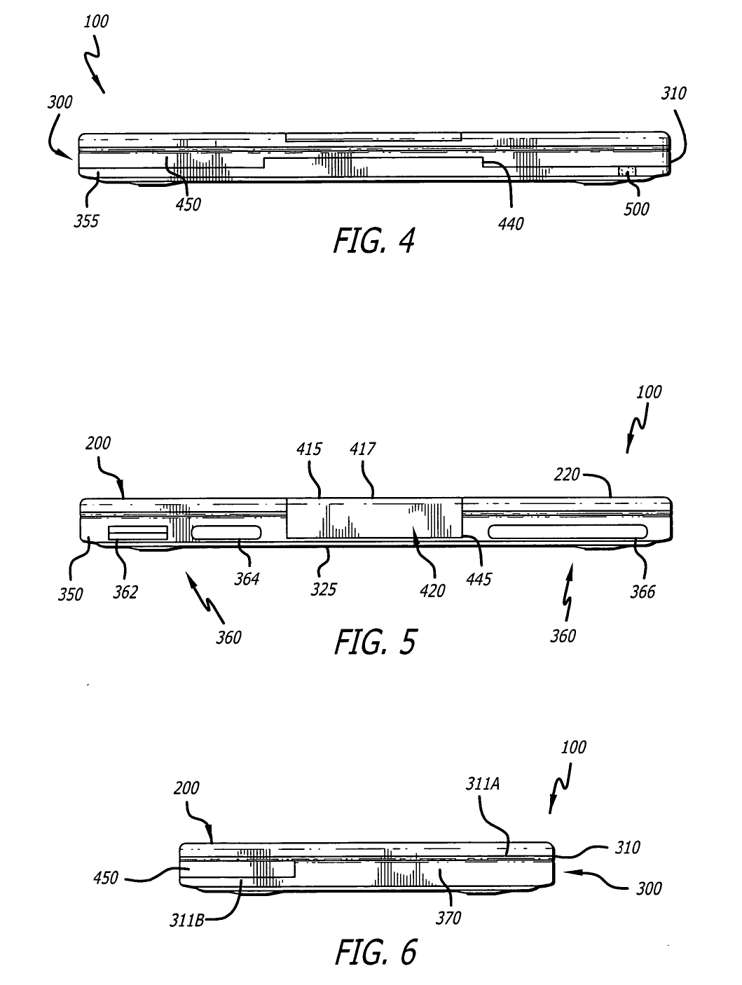

Referring now to FIG. 4, a front view of electronic apparatus 100 of FIG. 1 is shown. According to one embodiment of the invention, a first hinge assembly 440 is mounted on top panel 310 and proximate to a front edge 355 of body 300. Herein, first hinge assembly 440 operates as a brake hinge to maintain a selected orientation of display support unit 450 after vertical rotation shown in FIGS. 15-18.

Although not shown, first hinge assembly 440 comprises at least two end units having apertures (or indents) with ends of a shaft inserted into the apertures (or indents). Fixedly secured to body 300 or a component herein, the end units may be adapted to slightly discourage rotation of the shaft, thereby operating as a brake hinge. It is contemplated, however, that first hinge assembly 440 may operate as a non-brake hinge, provided there is a locking mechanism in place to maintain display support unit 450 in a rotated position.

As an optional feature, a wireless sensor 500 may be positioned along front edge 355 of body 300. According to one embodiment of the invention, wireless sensor 500 detects infrared signals from a remote control or another wireless input device. However, it is contemplated that wireless sensor 500 may be a RF sensor if no line-of-sight signaling is desired.

Referring to FIG. 5, a rear view of electronic apparatus 100 of FIG. 1 is shown. According to one embodiment of the invention, a second hinge assembly 445 is positioned at rear edge 350 of body 300. Second hinge assembly 445 also operates as a brake hinge, where some resistance is applied during vertical rotation of support arm 415, along with display housing 200 coupled thereto. Moreover, second hinge assembly 445 is adapted to enable display housing 200 to be repositioned and coplanar with a rotated display support unit 450 of FIG. 4.

Herein, since second hinge assembly 445 is positioned toward bottom surface 325 of body 300, support arm 415 comprises a first end 420 that is angled for coupling to second hinge assembly 445. The first angled end 420 is generally orthogonal to top surface 417 of support arm 415.

Additionally, a plurality of interfaces 360 are situated along rear edge 350 of body 300. For instance, a first interface 362 may be adapted as a serial communication port for receipt of a connector of a peripheral such as a modem, a desktop mouse, or another type of peripheral supporting serial data transmissions. An example of first interface 362 may include, but is not limited or restricted to a Universal Serial Bus (USB) port operating in accordance with USB version 2.0. In addition, a second interface 364 may be adapted as a parallel communication port (e.g., RS-232 port) for receipt of a connector of a peripheral device such a printer.

It is contemplated that rear edge 350 of body 300 may be configured with additional interfaces. As an illustrative example, a bay 366 may be situated along edge 350 below back panel 220 to receive a portable memory device (e.g., PCMCIA card) or a wireless network card.

Referring to FIG. 6, a side view of electronic apparatus 100 of FIG. 1 is shown. Herein, display housing 200 is positioned proximate to display support unit 450 and first-tier 311A of top panel 310. Display support unit 450 is positioned proximate to second-tier 311B of top panel 310.

According to one embodiment, although not shown, a bay for a mechanical or optical drive may be situated along a side edge 370 of body 300 for receipt of a portable storage medium such as a digital versatile disc (DVD), a compact disc (CD), a digital tape, a floppy disk, USB memory stick or the like.

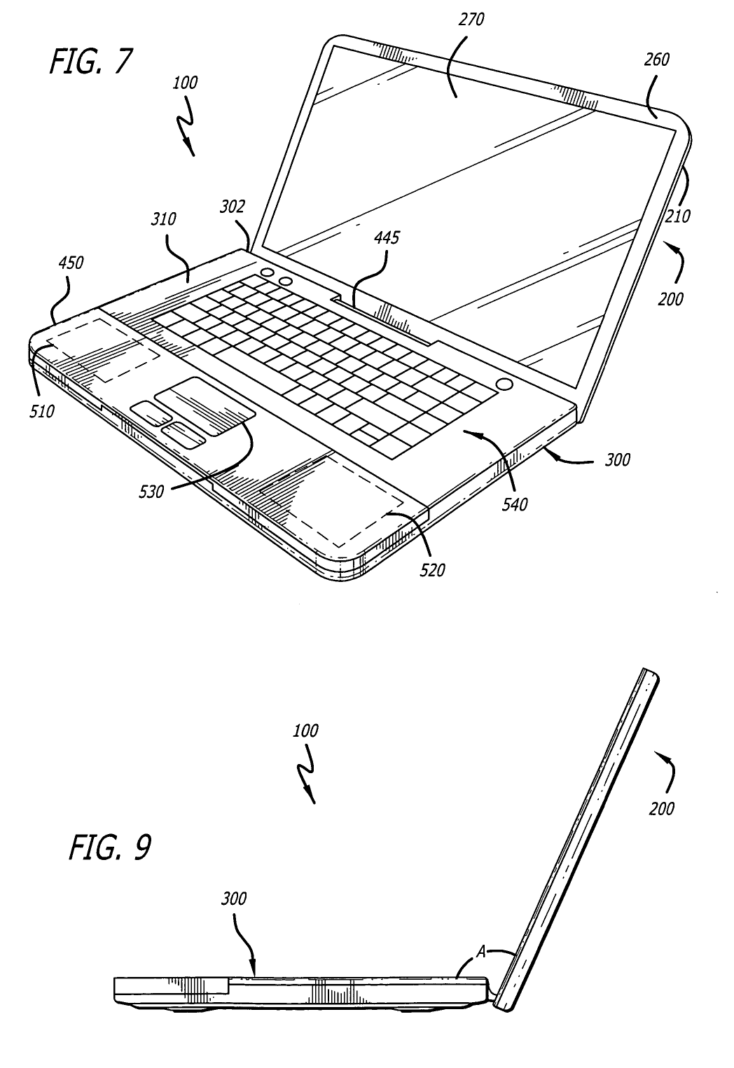

Referring now to FIG. 7, a perspective view of the first exemplary embodiment of electronic apparatus 100 placed in a first operational state is shown. Herein, display housing 200 comprises a front panel 260 surrounding the perimeter of a flat panel display 270. The combination of front panel 270 and back panel 210 encases the circuitry for generating a displayable image on flat panel display 270. Examples of flat panel display 270 include, but are not limited or restricted to a liquid crystal display (LCD), a plasma display, or the like.

Display housing 200 is rotationally coupled to body 300 through second hinge assembly 445. Due to placement of second hinge assembly 445 below a top surface of top panel 310, display housing 200 partially protrudes below a rear top edge 302 of body 300.

According to this embodiment of the invention, dual speakers (not shown) are integrated into display support unit 450. Hence, pin-sized openings 510 and 520 are formed within display support unit 450 in order to allow audio produced by the speakers to freely propagate. These openings 510 and 520 are visible when electronic apparatus 100 is placed in the first operational state as shown, but are covered by display housing 200 when electronic apparatus 100 is placed in a closed state.

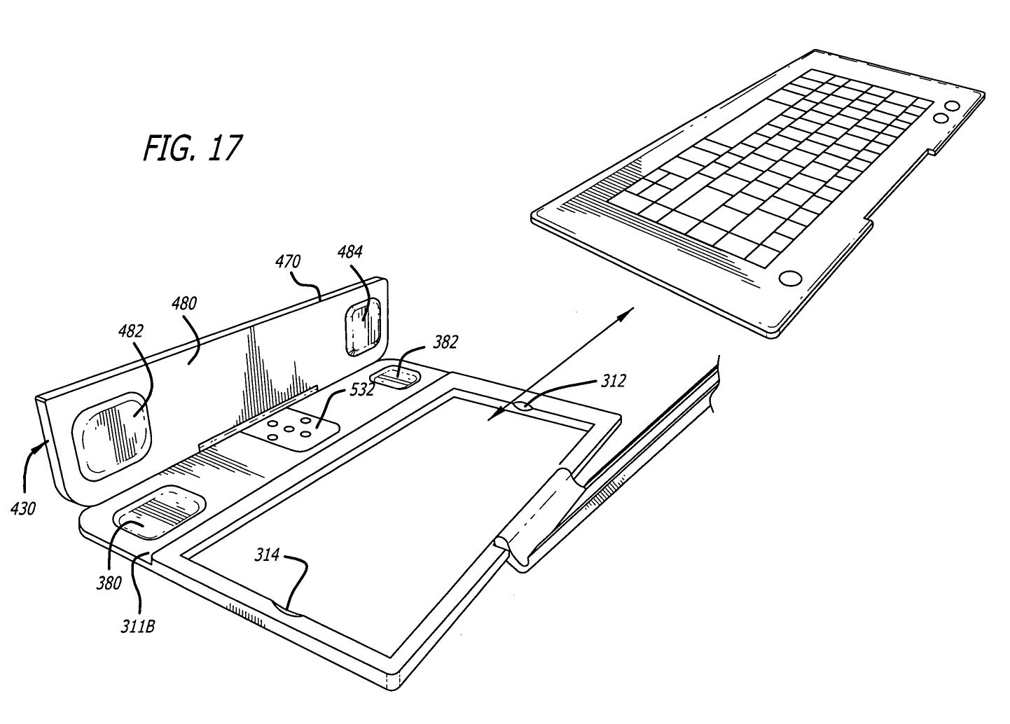

In addition, a pointing device 530 may be integrated into display support unit 450. Examples of the pointing device 530 may include, but are not limited or restricted to a touchpad or track ball for example. The sensors (not shown) for detecting usage of pointing device 530 are maintained in a recessed portion of body 300 as shown in FIG. 17.

As further shown in FIG. 7, in the first operational state, electronic apparatus 100 provides the user access to an input device 540. According to one embodiment, input device 540 is a removable keyboard that is adapted for wireless connectivity with electronic apparatus 100. The removable keyboard 540 is situated in a recessed area formed within first-tier 311A of body 300. According to another embodiment, input device 540 is a keyboard integrated into body 300. For both of these embodiments, keyboard 540 is sufficiently adjusted in height to avoid contact with flat panel display 270 when electronic apparatus 100 is placed in a closed state as shown in FIG. 6.

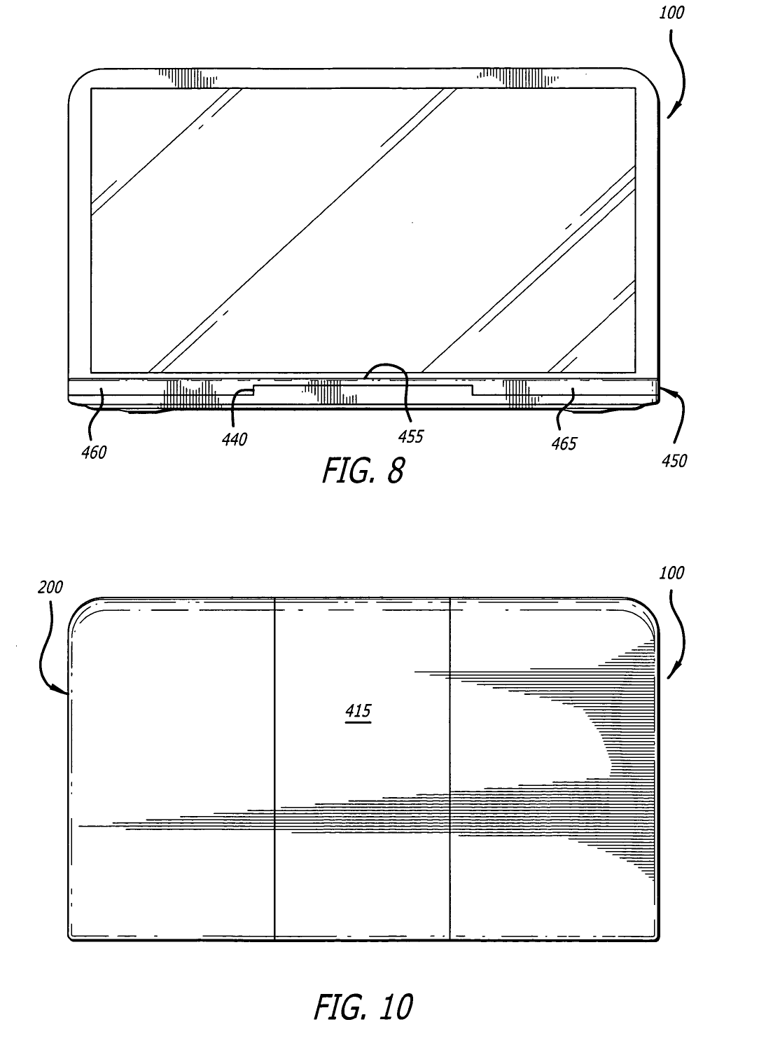

Referring to FIG. 8, a front view of electronic apparatus 100 placed in the first operational state as shown in FIG. 7 is shown. Rotationally coupled to first hinge assembly 440, display support unit 450 comprises a center portion 455 and two end portions 460 and 465. Center portion 455 is patterned in order to clear first hinge assembly 440 when display support unit 450 is vertically rotated. End portions 460 and 465 are substantially thicker than center portion 455 to accommodate the speakers.

Referring now to FIG. 9, a side view of electronic apparatus 100 placed in the first operational state as shown in FIG. 7 is illustrated. Herein, display housing 200 is vertically rotated from a position substantially in parallel with a top surface of body 300 by an angle “A”, which exceeds ninety degrees. In the first operational state, electronic apparatus 100 operates as a laptop computer.

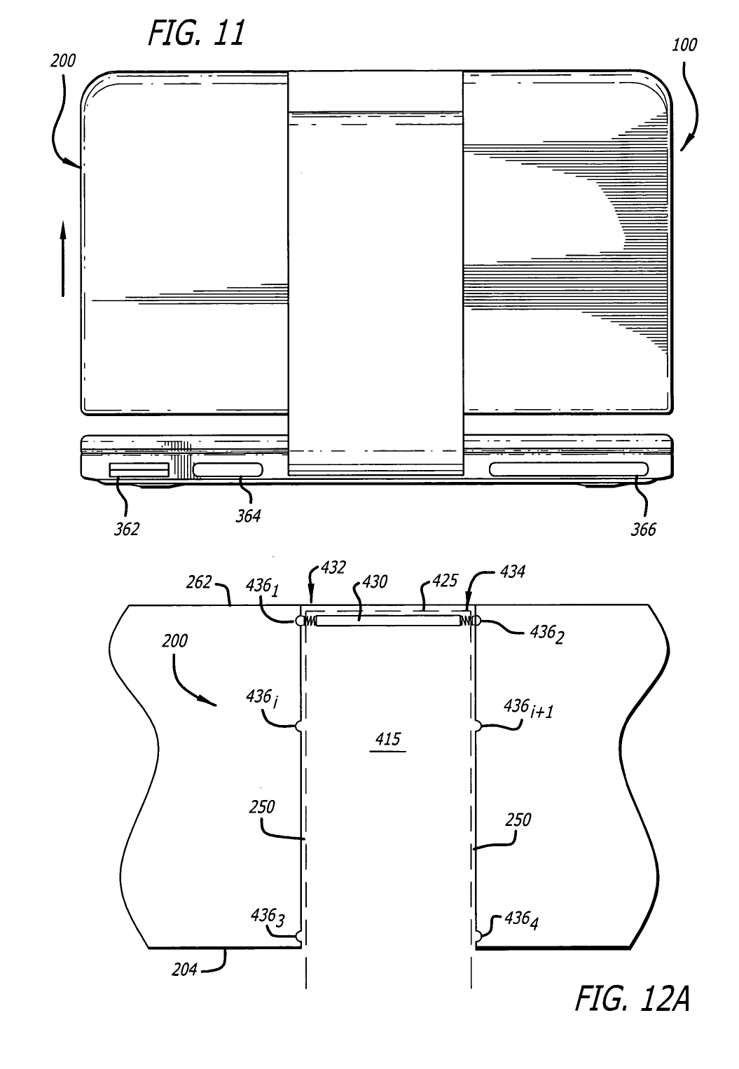

Referring now to FIG. 10, a rear view of electronic apparatus 100 placed in the first operational state as shown in FIG. 7 is illustrated. According to this embodiment of the invention, the second hinge assembly (not shown) is positioned toward the bottom surface of body. As a result, vertical rotation of support arm 415 and display housing 200, in order to place electronic apparatus 100 in the first operational state and display housing 200, in a first position, substantially covers of the rear edge of the body. This requires upward lateral movement of display housing 200 to provide sufficient clearance for interfaces 362, 364 and/or 366 situated along rear edge 350 of body 300 as shown in FIG. 11.

As shown in FIG. 12A, a first exemplary embodiment of the mechanics of display adjustment unit 410 is shown. Herein, a second end 425 of support arm 415 features a hinge shaft 430 with spring-loaded ball bearings 432 and 434 on each side of shaft 430. Two sets of detents 436₁-436₄ are positioned within channel guides 250 near a top edge 202 and bottom edge 204 of display housing 200. It is further contemplated that additional detent pairs 436ᵢ-436ᵢ₊₁ (5≦i≦j) may be positioned between detents 436₁-436₄. This provides one or more intermediary lateral position for display housing 200 as shown in FIG. 11.

Referring now to FIGS. 12B-12C, second exemplary embodiments of the mechanics of display adjustment unit 400 are shown. Herein, as shown in FIG. 12B, second end 425 of support arm 415 features a pair of pulleys 600 and 610 fixedly secured proximate to edges 418 and 419 of support arm 415. Each bias element (e.g., spring) 620 and 630 is coupled at one end to body 300 and at another end to a wire 640 and 650, respectively. Wires 640 and 650 are wound over pulleys 600 and 610 for coupling near bottom edge 204 of display housing 200. Hence, when electronic apparatus 100 is in the closed state and first operational state as shown in FIG. 12B, springs 620 and 630 are stretched. In contrast, as display housing 200 is laterally moved in an upward direction, springs 620 and 630 progressively return to a non-stretched state, which is achieved when display housing 200 is moved to an elevated position.

The third exemplary embodiments of the mechanics of display adjustment unit 400 are shown in FIGS. 12D-12E. As shown in these figures, gears 700 and 710 are positioned proximate to edges 418 and 419 of support arm 415, near second end 425 of support arm 415. The teeth of these gears 700 and 710 are sized to engage with grooves formed within racks 720 and 730, respectively. Racks 720 and 730 are situated (i.e., formed or installed) along longitudinal ends 240 and 242 of recessed area 240.

As a result, when electronic apparatus 100 is in the closed state and first operational state as shown in FIG. 12D, gears 700 and 710 are engaged with grooves at top ends 722 and 732 of racks 720 and 730. As display housing 200 is laterally moved in an upward direction, gears 700 and 710 are rotated to successively engage with grooves along racks 720 and 730 toward their bottom ends 724 and 734 as shown in FIG. 12E. Being adapted with a pre-tensioned spring for high torque, gears 700 and 710 will not freely rotate in a clockwise and counter-clockwise direction after display housing 200 is laterally moved along support arm 415 and left at an elevated position.

Referring now to FIGS. 12F-12G, the fourth exemplary embodiments of the mechanics of display adjustment unit 400 are shown. Herein, the mechanics involve a combination of the pulley-wire mechanism of FIGS. 12B-12C and the gear-rack mechanism of FIGS. 12D-12E. According to this embodiment of the invention, high-torque gears 800 and 810 are cylindrical in shape and include a first cylindrical portion 802 and 812 and a second cylindrical portion 804 and 814, respectively. First cylindrical portions 802 and 812 include teeth to engage with racks 720 and 730. Second cylindrical portions 804 and 814 are generally concave in shape to receive wires 640 and 650 and operate as a pulley.

Hence, when electronic apparatus 100 is in the closed state and first operational state as shown in FIG. 12F, gears 800 and 810 are engaged with grooves at top ends 722 and 732 of racks 720 and 730. Also, gears 800 and 810 receive wires 640 and 650, which are attached to display housing 200 to cause springs 620 and 630 to be placed in a stretched state. As display housing 200 is laterally moved in an upward direction as shown in FIG. 12G, gears 800 and 810 are rotated to successively engage with grooves toward bottom ends 724 and 734 of racks 720 and 730. This causes springs 620 and 630 to progressively return to their non-stretched state.

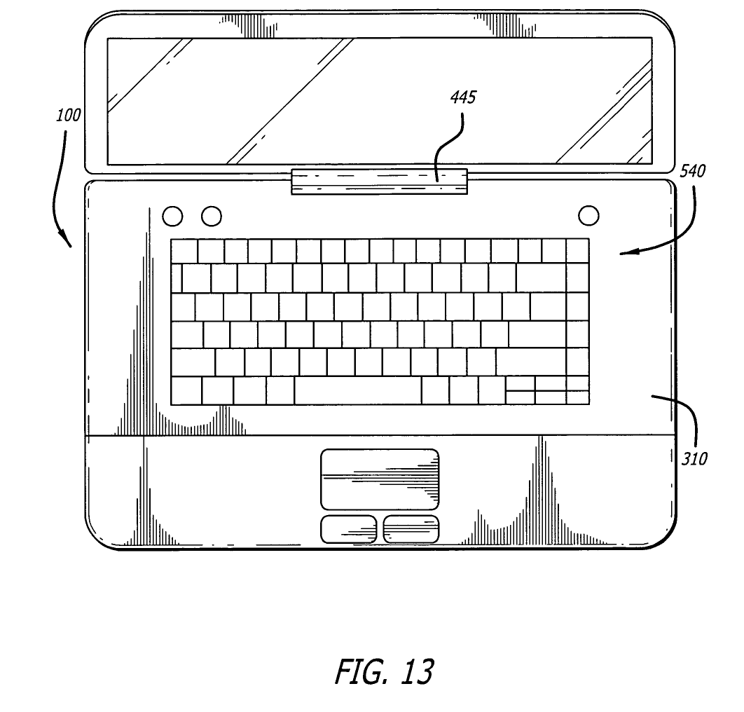

Referring now to FIG. 13, an overhead view of electronic apparatus 100 placed in the first operational state as shown in FIG. 7 is illustrated. When keyboard 540 has wireless keyboard functionality, recesses 312 and 314 (see FIG. 17) may be placed on a surface of top panel 310 to enable easier removal of keyboard 540 as further illustrated in FIG. 17.

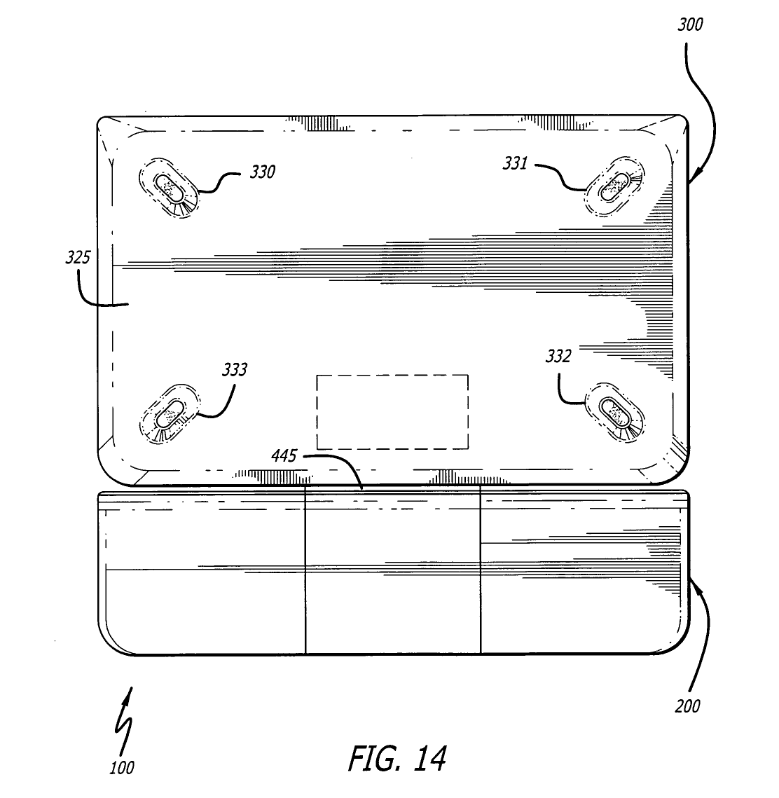

FIG. 14 illustrates a view of bottom surface 325 of body 300 of electronic apparatus 100 placed in the first operational state as shown in FIG. 7. Herein, grommets 330-333 are positioned according to the same arrangement described in FIG. 3. Display housing 200, however, is vertically rotated and maintained in position by second hinge assembly 445.

Referring now to FIG. 15, a perspective view of electronic apparatus 100 during conversion from a first operational state to a second operational state is shown. According to one embodiment of the invention, display housing 200 is laterally moved in an upward direction and display support unit 450 is vertically rotated for subsequent physical support of display housing 200.

More specifically, display housing 200 is laterally moved in a substantially upward direction. According to one embodiment of the invention, this would cause a spring-loaded hinge shaft, positioned at the second end (not shown) of support arm 415, to laterally move along channel guides positioned below back panel 210. The second end of support arm 415 is moved from top edge 202 toward bottom edge 204 of display housing 200. Upon encountering each detent, the hinge shaft is secured.

In addition, display support unit 450 is vertically rotated about an angle “B”, where 45°≦B≦135°. As a result, a first edge 470, normally closest to keyboard 540, is situated above a second edge 475. Therefore, when electronic apparatus 100 is placed in the second operational state, bottom edge 204 of display housing 200 is supported by first edge 470.

Referring to FIG. 16, a perspective side view of electronic apparatus 100 during conversion as shown in FIG. 15 is illustrated. Second hinge assembly 445 is configured as a brake hinge to maintain a laterally elevated display housing 200 without unwanted vertical rotation of support arm 415.

Referring now to FIG. 17, a perspective view of a top surface of body 300 with display support unit 450 rotated to support display housing 200 is illustrated. Herein, a bottom surface 480 of display support unit 450 comprises two protrusions 482 and 484 in order to accommodate the speakers. Recessed areas 380 and 382, corresponding in shape to protrusions 482 and 484, are formed at second-tier 311B of top panel 310. Remote controller 532 is secured in a recess arranged between recessed areas 380 and 382 and can be removed from the recess after display support unit 450 is rotated. Remote controller 532 is used to change a television channel, turn down/up the volume and the like when the electronic apparatus is placed in the second operational state and operates as a television.

Although not shown, a locking mechanism is formed in display support unit 450 to maintain display housing 200 when placed thereon. An example of a locking mechanism may include, but is not limited or restricted to, one or more complementary pairs of magnetic couplers, which are placed along first edge 470 and a corresponding location of bottom edge 204 of display housing 200 shown in FIG. 16. Another example of a locking mechanism includes a pair of complementary fasteners (e.g. latches, latch pin and slot, etc.) positioned in both display housing 200 and display support unit 450. When activated by a user, these fasteners securely attach display housing 200 to display support unit 450.

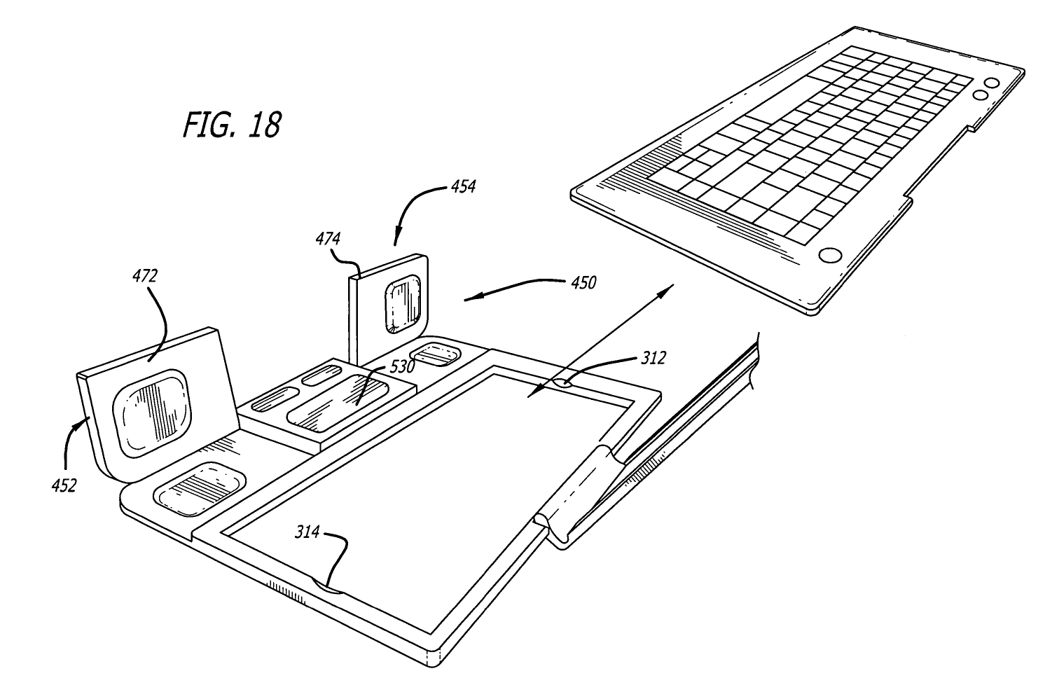

Referring now to FIG. 18, it is contemplated, that display support unit 450 may be separated into a plurality of sub-units 452 and 454. For instance, according to one embodiment of the invention, sub-units 452 and 454 are independently and rotationally coupled to body 300. According to this alternative embodiment, pointing device 530 would remain fixed to body 300 while sub-units 452 and 454, inclusive of the speakers, would be rotated. As a result, the bottom edge 204 of the display housing 200 would rest on and be secure to the top edges 472 and 474 of sub-units 452 and 454, respectively.

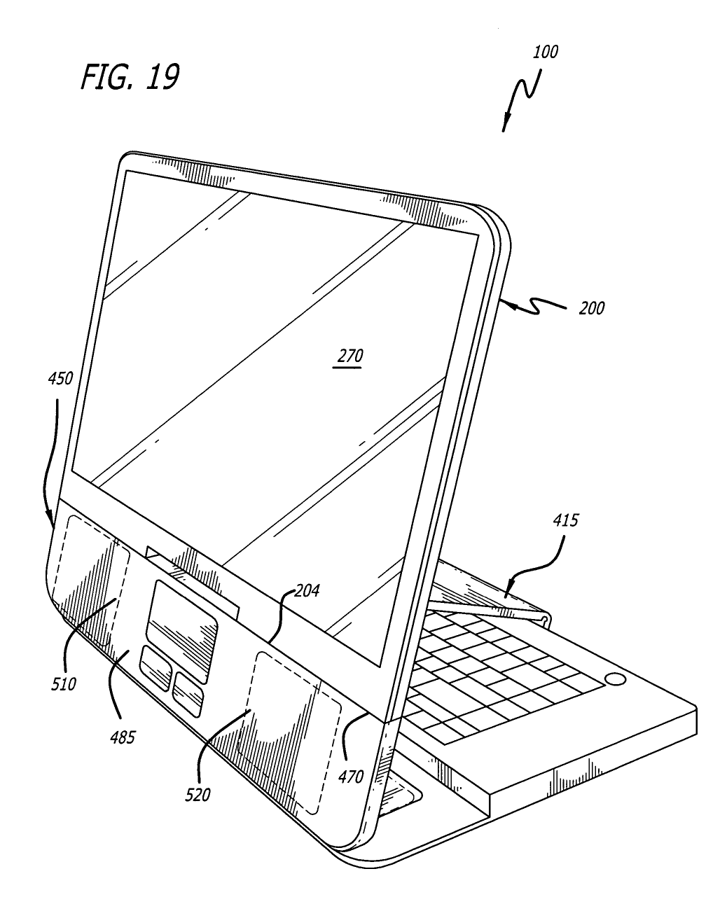

Referring to FIG. 19, a perspective view of the first exemplary embodiment of electronic apparatus 100 placed in a second operational state is shown. According to this embodiment, bottom edge 204 of display housing 200 rests on first edge 470 of display support unit 450 and is now situated in a second position. Display adjustment unit 410 maintains display housing 200 in a generally vertical orientation while the first hinge assembly (not shown) maintains display support unit 450 is a generally vertical orientation.

As a result, flat panel display 270 is substantially coplanar with display support unit 450 so that speaker openings 510 and 520 are oriented in a direction toward the viewer of flat panel display 270. Moreover, the display surface of flat panel display 270 is substantially coplanar to a top surface 485 of display support unit 450.

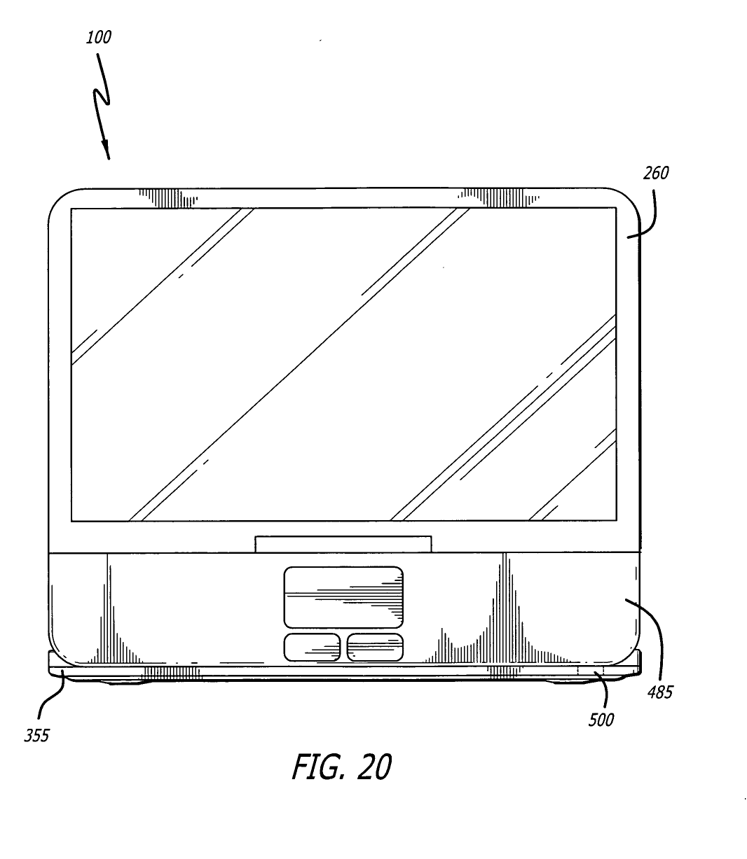

Referring now to FIG. 20, a front view of electronic apparatus 100 of FIG. 19 is illustrated. As shown, wireless sensor 500 may be positioned at front edge 355 of body 300. It is contemplated, however, that wireless sensor 500 may be alternatively implemented on top surface 485 of display support unit 450 or on front panel 260 of display housing 200. Wireless sensor 500 enables the user to input commands from an input device (e.g., remote control, wireless keyboard, etc.) to cause execution of internal software that enables electronic apparatus 100 to operate as a remote-computer or as a television.

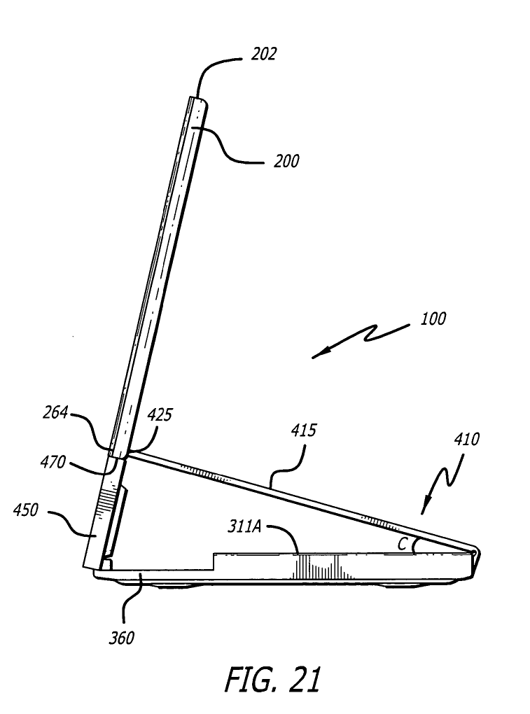

Referring to FIG. 21, a side view of electronic apparatus 100 placed in the second operational state as shown in FIG. 19 is illustrated. Display housing 200 is positioned on first edge 470 of display support unit 450. Such positioning occurred in response to upward lateral movement of display housing 200, which caused second end 425 of support arm 415 to move from top edge 202 toward bottom edge 204. When display adjustment unit 410 is vertically rotated back toward a top surface of body 300, the vertex of the angle (C) between support arm 415 and top surface of first-tier 311A becomes generally acute (e.g., C<45°).

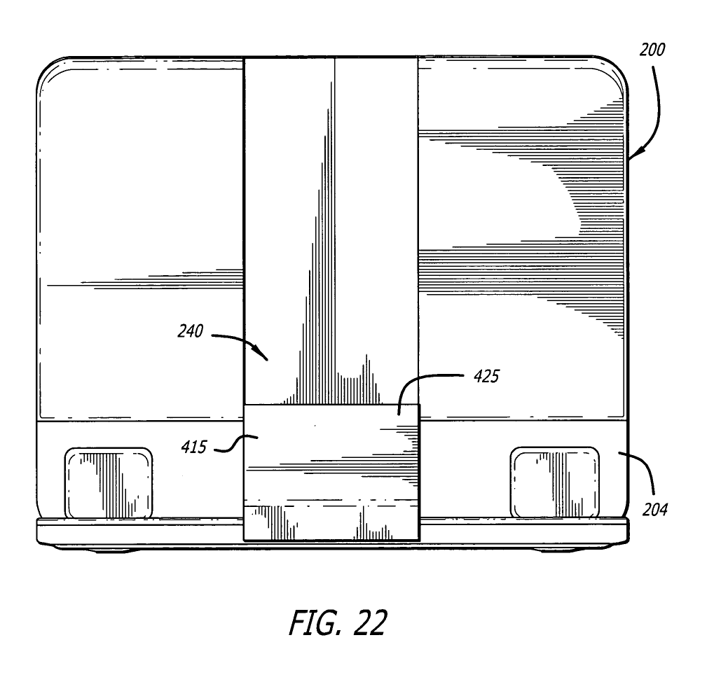

Referring to FIG. 22, a rear view of electronic apparatus 100 placed in the second operational state as shown in FIG. 19 is illustrated. As shown, second end 425 of support arm 415 is now situated proximate to a bottom edge of recessed area 240 and bottom edge 204 of display housing 200. In this position, a substantial portion of recessed area 240 is visible to the user.

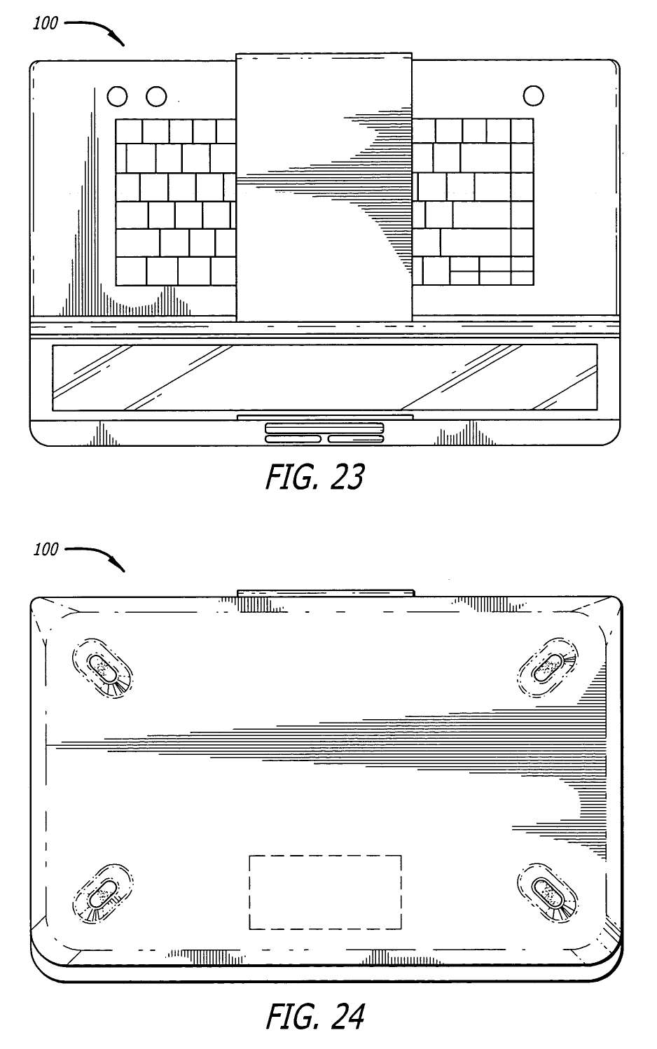

FIGS. 23 and 24 illustrate overhead view and a bottom view of electronic apparatus 100 placed in the second operational state as shown in FIG. 19.

### II. Second Embodiment of the Electronic Apparatus

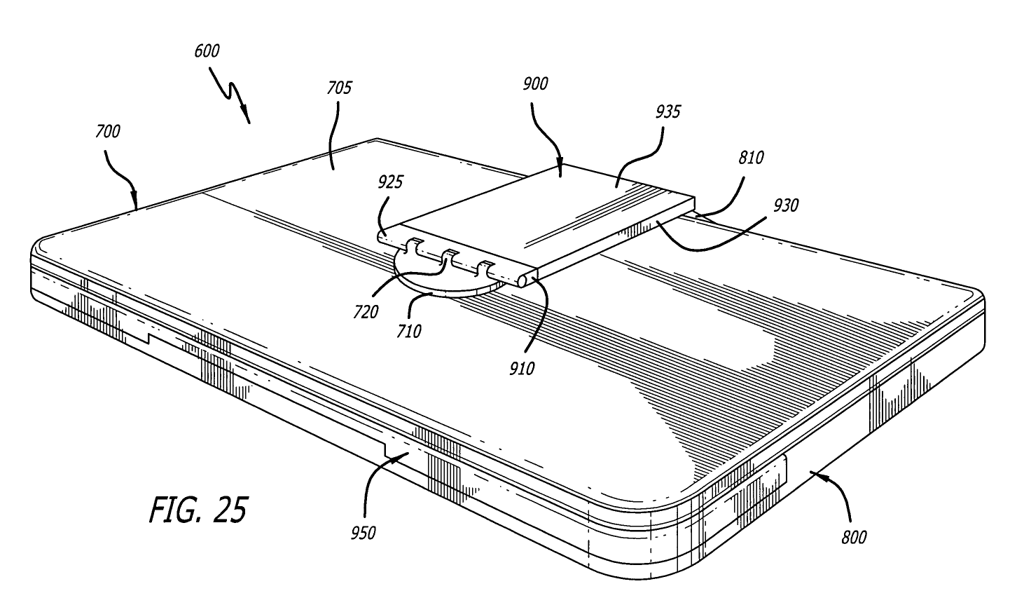

Referring now to FIG. 25, a perspective view of a second exemplary embodiment of an electronic apparatus 600 placed in a closed state is shown. Similarly, electronic apparatus 600 comprises a display housing 700, a body 800 and a display support mechanism including a display adjustment unit 900 and a display support unit 950. While display support unit 950 is identical in construction and operation as display support unit 450 of FIG. 1A, display adjustment unit 900 differs as shown.

Display adjustment unit 900 comprises a top support arm 910 and a bottom support arm 930. Top support arm 910 is rotationally coupled to display housing 700 by a first fastener 710. Bottom support arm 930, however, is rotationally coupled to base case 800.

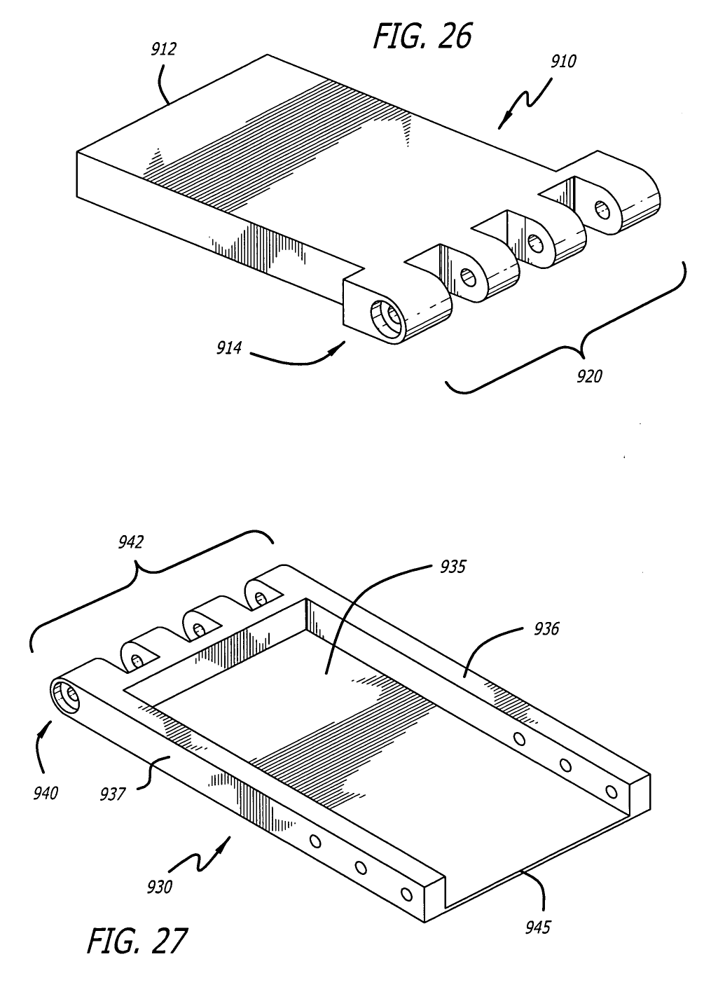

As shown in FIGS. 25 and 26, top support arm 910 comprises a first end 912 and a second end 914. First end 912 is placed within a recessed area 935 formed in bottom support arm 930. Second end 914, however, is rotationally coupled to first fastener 710 affixed to a back panel 705 of display housing 700.

According to one embodiment, second end 914 of top support arm 910 comprises a plurality of hollowed protrusions 920, which are appropriately spaced to interlock with hollowed protrusions 720 of first fastener 710. A hinge shaft 925 is inserted through hollowed protrusions 720 and 920 and adjustments are made for first fastener 710 to operate as a brake hinge.

As shown in FIGS. 25 and 27, bottom support arm 930 comprises a first end 940 and a second end 945 separated by recessed area 935, which is sized to receive a substantial portion of top support arm 910 when electronic apparatus 600 is in the closed state. First end 940 comprises a plurality of hollowed protrusions 942, which are appropriately spaced to interlock with hollowed protrusions of a second fastener 810 placed on a top surface of body 800.

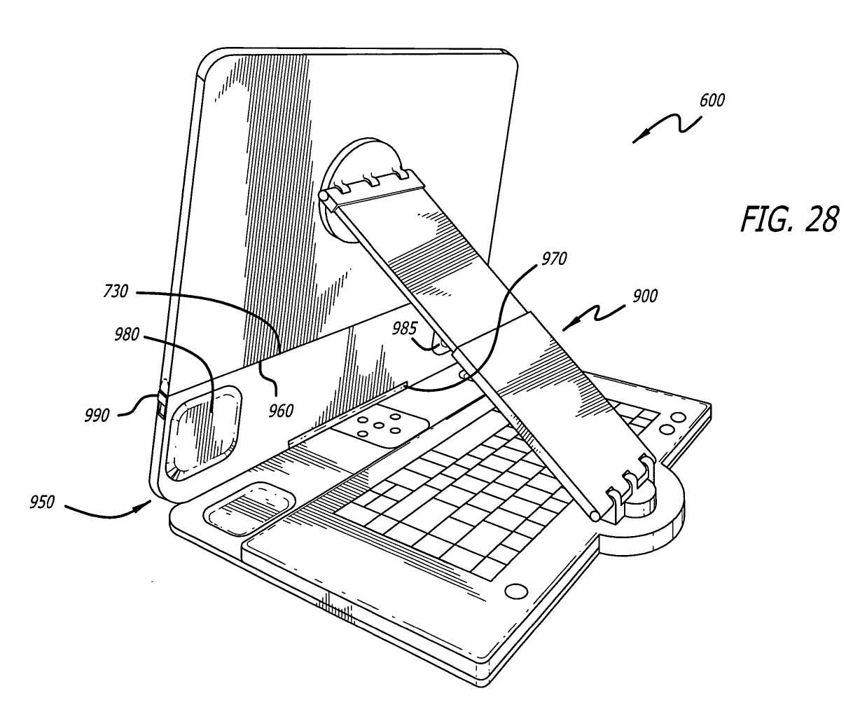

Top support arm 910 is partially positioned in recessed area 935 of bottom support arm 930 and is movably attached to edges 936 and 937 of bottom support arm. Such attachment may be through any conventional means such as guide rails, detents, and the like. This enables top support arm 910 to be laterally adjusted in a telescopic fashion as shown in FIG. 28.

Referring to FIG. 28, a perspective view of the second exemplary embodiment of electronic apparatus 600 placed in a second operational state is shown. According to this embodiment, a bottom edge 730 of display housing 700 rests on a first edge 960 of display support unit 950. Display adjustment unit 900 maintains display housing 700 in a generally vertical orientation. A hinge assembly 970, identical in construction and operation as the first hinge assembly of FIG. 1A, maintains display support unit 950 is a generally vertical orientation.

As a result, display housing 700 is substantially coplanar to display support unit 950 so that both a flat panel display (housed by display housing 700) and speakers 980 and 985 are oriented in a direction toward the viewer of the flat panel display. A locking mechanism 990, featuring a fastener that, automatically or manually, becomes engaged with and disengaged from a slot formed at a bottom edge 730 of display housing 700. Locking mechanism 990 securely fastens display housing 700 to display support unit 950.

In the foregoing description, the invention is described with reference to specific exemplary embodiments thereof. It will, however, be evident that various modifications and changes may be made thereto without departing from the broader spirit and scope of the present invention as set forth in the appended claims. For example, the display adjustment unit may be designed to expand across the width of the display housing (or a substantial portion thereof) and attach to the back of the display housing by a brake hinge assembly. In the event that the display adjustment unit expands across the entire width of the display housing, the brake hinge assembly would also expand accordingly, with attachment at both ends to an edge of the display housing.

Therefore, the specification and drawings are accordingly to be regarded in an illustrative rather than in a restrictive sense.

1. An apparatus comprising:
a body having a first edge and a second edge;
a display housing;
a display adjustment unit coupled to the display housing and rotationally coupled to the body proximate to the first edge of the body; and
a display support unit rotationally coupled to the body, the display support unit being rotated to support the display housing when the display housing is moved from a first position to a second position.

2. The apparatus according to claim 1, wherein the display support unit is rotationally coupled proximate to the second edge of the body.

3. The apparatus according to claim 1, wherein the display support unit comprises at least one speaker.

4. The apparatus according to claim 1, wherein the body comprises a first panel having a recessed area for placement of a keyboard and a second panel interconnected to the first panel.

5. The apparatus according to claim 4, wherein the display support unit comprises an edge adjacent to a portion of the first panel surrounding the recessed area when the display housing is in the first position and is in direct contact with a bottom edge of the display housing when the display housing is in the second position.

6. The apparatus according to claim 4, wherein the display support unit comprises a bottom surface that is substantially flush against a top surface of a portion of the first panel when the display support unit is in a non-rotated state and is angled at an angle ranging between 45 degrees and 135 degrees from the top surface of the portion of the first panel when the display support unit is rotated.

7. The apparatus according to claim 1, wherein the display housing comprises a flat panel display.

8. The apparatus according to claim 7, wherein a top surface of the display support unit is substantially coplanar with a display surface of the flat panel display when the display housing is placed in the second position.

9. The apparatus according to claim 1 operating as a computer when the display housing is placed in the first position and as a television when the display housing is placed in the second position.

10. The apparatus according to claim 1 further comprising a locking mechanism to secure the display housing to the display support unit with the display housing is placed in the second position.

11. An apparatus adapted for placement in a first operational state and a second operational state, comprising:
a body including a keyboard positioned between a front edge and a rear edge;
a display housing;
a display support mechanism including a display adjustment unit for rotation of the display housing and a display support unit having at least one speaker rotationally coupled to the front edge of the body by a hinge assembly, the display support unit being rotated into a rotated position for supporting the display housing when the display housing is moved toward the front edge of the body.

12. The apparatus according to claim 11, wherein the display support unit of the display support mechanism is rotated so that a bottom edge of the display housing rests on an edge of the display support unit closer to the keyboard than the front edge of the body when the display support unit is in a non-rotated position.

13. The apparatus according to claim 12, wherein display support unit of the display support mechanism further comprises a pointing device.

14. The apparatus according to claim 11, wherein the display support unit of the display support mechanism comprises a bottom surface that is (i) substantially flush against a top surface of the body when the display support unit is in a non-rotated position and (ii) angled at an angle ranging between 45 degrees and 135 degrees from the top surface of the body when the display support unit is placed into the rotated position.

15. An electronic apparatus, comprising:
a body having a first edge and a second edge;
a display housing adapted for movement from a first position to a second position;
a display adjustment unit coupled to the display housing and rotationally coupled to the body proximate to the first edge of the body; and
a display support unit rotationally coupled to the body, the display support unit having an edge in contact with a bottom edge of the display housing when the display housing is in the second position.

16. The electronic apparatus according to claim 15, wherein the display support unit comprises:
at least one speaker; and
a pointing device situated on a top surface of the display support unit.

17. The electronic apparatus according to claim 16, wherein the body comprises at least one recess sized for a protrusion formed in a bottom surface of the display support unit to accommodate the at least one speaker.

18. The electronic apparatus according to claim 15, wherein the display housing comprises a flat panel display.

19. The electronic apparatus according to claim 18, wherein the top surface of the display support unit is substantially coplanar with a display surface of the flat panel display when the display housing is placed in the second position.

20. The electronic apparatus according to claim 15, wherein the display support unit further comprises a bottom surface that is substantially flush against a top surface of the body when the display support unit is in a non-rotated state and is angled at an angle ranging between 45 degrees and 135 degrees from the top surface of the body when the display support unit is rotated.

21. The electronic apparatus according to claim 15, wherein the display housing is moved from the first position to the second position by lateral upward movement of the display housing away from the body and vertical rotation of a support arm of the display adjustment unit toward the first edge of the body for placement of the bottom edge of the display housing on the edge of the display support unit

22. The electronic apparatus according to claim 15, wherein the display support unit comprises a plurality of edges forming a perimeter, the edge of the plurality of edges to support the display housing when the display support unit is rotated and the display housing is moved from the first position to the second position where the display housing is closer to the first edge than the second edge of the body.

23. A method comprising:
vertically rotating a display support unit positioned proximate to a front edge of a body of an electronic apparatus;
vertically rotating a support arm toward the front edge of the body; and
attaching the display housing to the display support unit so that a display screen of a flat panel display housed by a display housing is substantially co-planar to a top surface of the display support unit.

24. The method according to claim 23, wherein prior to vertically rotating the display support unit, the method further comprises:
adjusting the display housing in a lateral upward direction along the support arm that is rotationally coupled to both the display housing and a rear edge of the body.
